(19) United States
(12) Patent Application Publication
(10) Pub. No.: US 2026/0148425 A1
(43) Pub. Date: May 28, 2026

(54) JOINT INTRINSIC LAYERS FROM LATENT DIFFUSION MODELS

(71) Applicant: ADOBE INC., SAN JOSE, CA (US)

(72) Inventors: Yangtuanfeng Wang, London (GB); Jundan Luo, Cardiff (GB); Duygu Ceylan Aksit, London (GB); Jae Shin Yoon, San Jose, CA (US); Nanxuan Zhao, San Jose, CA (US); Julien Olivier Victor Philip, London (GB); Anna Fruehstueck, London (GB)

(21) Appl. No.: 18/956,138

(22) Filed: Nov. 22, 2024

(51) Int. Cl. G06T 11/00

(52) U.S. Cl. CPC G06T 11/00

(57) ABSTRACT

A method, apparatus, non-transitory computer readable medium, and system for generating synthetic output includes obtaining an input image depicting a scene and an input prompt indicating an intrinsic modality of the input image, wherein the intrinsic modality determines how the scene interacts with light. A conditional image encoder encodes the input image to obtain a condition embedding representing the intrinsic modality of the input image. An image generation model generates a synthetic output based on the input prompt and the condition embedding, wherein the synthetic output comprises a visual representation of the intrinsic modality of the input image.

### BACKGROUND

The following relates generally to image processing, and more specifically to image decomposition using a machine learning model. Machine learning algorithms build a model based on sample data, known as training data, to make a prediction or a decision in response to an input without being explicitly programmed to do so. One area of application for machine learning is image editing.

For example, a machine learning model can be trained to predict information for an image in response to an input prompt, and to then generate an output based on the predicted information. In some cases, the prompt can be used to perform complex image manipulation and compositing. The generated output provides for a user to edit an image and generate an image with desired features and therefore makes image editing easier for a layperson and also more readily automated.

### SUMMARY

Systems and methods are described for intrinsic image decomposition. Embodiments of the present disclosure include an image generation model comprising a conditional image encoder and a control network. In some cases, the image generation model is configured to jointly predict multiple intrinsic modalities from an input image (e.g., shading, albedo, depth, or surface normal). The conditional image encoder extracts features from the input image and maps the features to domain-specific embedding vectors. In some cases, the domain-specific embedding vectors are used as a conditioning input for a diffusion network that is guided using a control network.

A method, apparatus, and non-transitory computer readable medium for image processing are described. One or more aspects of the method, apparatus, and non-transitory computer readable medium include obtaining an input image depicting a scene and an input prompt indicating an intrinsic modality of the input image, wherein the intrinsic modality determines how the scene interacts with light; encoding, using a conditional image encoder, the input image to obtain a condition embedding representing the intrinsic modality of the input image; and generating, using an image generation model, a synthetic output based on the input prompt and the condition embedding, wherein the synthetic output comprises a visual representation of the intrinsic modality of the input image.

A method, apparatus, and non-transitory computer readable medium for image processing are described. One or more aspects of the method, apparatus, and non-transitory computer readable medium include obtaining training data including an input image and an input prompt indicating an intrinsic modality; generating a predicted condition embedding based on the input prompt; and training, using the training data and the predicted condition embedding, a conditional image encoder to generate a condition embedding for an image generation model, wherein the condition embedding represents the intrinsic modality of the input image.

An apparatus and system for image processing are described. One or more aspects of the apparatus and system include a memory component; a processing device coupled to the memory component, the processing device configured to perform operations comprising: obtaining an input image depicting a scene and an input prompt indicating an intrinsic modality; encoding, using a conditional image encoder, the input image to obtain a condition embedding representing the intrinsic modality of the input image; and generating, using an image generation model, a synthetic output based on the intrinsic modality and the condition embedding, wherein the synthetic output comprises a representation of the scene based on the intrinsic modality.

### BRIEF DESCRIPTION OF THE DRAWINGS

FIG. 1 shows an example of an image processing system according to aspects of the present disclosure.

FIG. 2 shows an example of a method for generating an image according to aspects of the present disclosure.

FIG. 3 shows an example of an image generation process according to aspects of the present disclosure.

FIG. 4 shows an example of an image generation model according to aspects of the present disclosure.

FIG. 5 shows an example of a transformer network according to aspects of the present disclosure.

FIG. 6 shows an example of a latent diffusion architecture according to aspects of the present disclosure.

FIG. 7 shows an example of a U-Net architecture according to aspects of the present disclosure.

FIG. 8 shows an example of a diffusion denoising process according to aspects of the present disclosure.

FIG. 9 shows an example of a method for image processing according to aspects of the present disclosure.

FIG. 10 shows an example of a method for training an image generation model according to aspects of the present disclosure.

FIG. 11 shows an example of a method of training a ML model according to aspects of the present disclosure.

FIG. 12 shows an example of a method for training a diffusion model according to aspects of the present disclosure.

FIG. 13 shows an example of a computing device according to aspects of the present disclosure.

FIG. 14 shows an example of an image processing apparatus according to aspects of the present disclosure.

FIG. 15 shows an example of an image generation model according to aspects of the present disclosure.

### DETAILED DESCRIPTION

The present disclosure describes systems and methods for image processing. In some cases, an image generation model of the present disclosure generates an output that depicts a scene of an input image based on an intrinsic modality provided by an input prompt. For example, the intrinsic modality of an image refers to an inherent property of an image that determines how elements within the image interact with light. For example, the intrinsic modalities of an image can include the reflectivity of the surfaces in the image (i.e., albedo layer), the interaction between the light and the surfaces in the image (a shading layer), and the direct underlying surface geometry (a surface normal layer).

Machine learning models may be used for intrinsic image decomposition. However, existing machine learning models cannot accurately predict the intrinsic properties from a single image due to the complexity associated with different combinations of intrinsic layers and lack of annotated scene-level datasets. Thus, existing machine learning models are unable to understand the implicit properties of a scene in an image (e.g., lighting conditions, appearance changes, etc.) and hence fail to perform intrinsic image decomposition accurately.

For example, existing machine learning models may generate intrinsic layers from an input image that are spatially distorted, i.e., do not match the appearance of the input image in terms of color and content. Additionally, existing methods generate outputs with undesired shadow regions, poor classification of input intensity variations, and high amount of texture residuals. Moreover, existing models may require access to datasets that provide annotations for each of the layers (e.g., all layers) during training, which is difficult since the amount of training data available for intrinsic image decomposition with ground-truth labels is orders of magnitude smaller than the data used to train the text-to-image model.

By contrast, embodiments of the present disclosure are able to perform multimodal training with a joint conditional image encoder that enables combining different types of annotations resulting in an improved intrinsic image decomposition. Systems and methods of the present disclosure perform joint learning in the conditional image encoder for generation of feature embeddings and use domain-specific text prompts to simultaneously condition a control network that is used to guide a generation process using a diffusion network.

Embodiments of the present disclosure are configured to perform intrinsic image decomposition based on a conditional image encoder that uses a control network to guide a pre-trained diffusion model. In some cases, the control network jointly predicts multiple intrinsic modalities (e.g., shading, albedo, surface normal) based on conditional vectors and a text prompt corresponding to each of the intrinsic modalities. In some cases, the conditional vectors are generated by the conditional image encoder.

An embodiment of the present disclosure includes a conditional image encoder configured to take an RGB image as input and efficiently generates conditional vectors corresponding to each of the intrinsic modalities. In some cases, the conditional image encoder comprises a sequence of residual blocks followed by a transformer network. In some cases, the transformer network includes domain-specific transformer layers that each generate feature-space conditioning vectors (i.e., condition vectors corresponding to each of albedo, shading, and surface normal modalities) based on the input RGB image.

According to an embodiment of the present disclosure, a control network is trained to jointly learn different output modalities. In some cases, the control network is trained by combining training data for different modalities (e.g., albedo, shading, and surface normal) with the corresponding text prompts. For example, the text prompt refers to the target modality (e.g., albedo, shading, or surface normal) and is modality-specific.

In some cases, an output of the control network is used to guide a latent diffusion model during the denoising process to generate a decomposed output, i.e., an intrinsic layer associated with the text prompt. For example, the weights of the latent diffusion model are frozen during the training process. In some examples, a zero signal-to-noise ratio (SNR) is ensured when sampling the noise. Accordingly, by enforcing the zero SNR, embodiments of the present disclosure are able to generate an output that is similar to the original data distribution resulting in an improved congruence between training and inference.

Additionally, an embodiment of the present disclosure includes a diffusion model that is configured to predict velocity (i.e., instead of noise). By implementing velocity prediction and velocity loss methods for the zero SNR, embodiments of the present disclosure are able to ensure understanding of a meaningful data distribution. In some cases, the different modalities are combined during training to accommodate for the multiple intrinsic modalities in the same latent space of the diffusion model. In some cases, the conditional image encoder and the control network are jointly optimized during the gradient back-propagation process.

Accordingly, by implementing the joint learning framework, embodiments of the present disclosure are able to combine different data sources with different types of annotations (i.e., resulting in a single training batch) during the training process resulting in an improved performance. Moreover, by providing the input image as condition to the control network that adapts to different modalities via the associated prompt, embodiments of the present disclosure are able to generate corresponding intrinsic layers, i.e., shading, albedo, and surface normal, from a single input image.

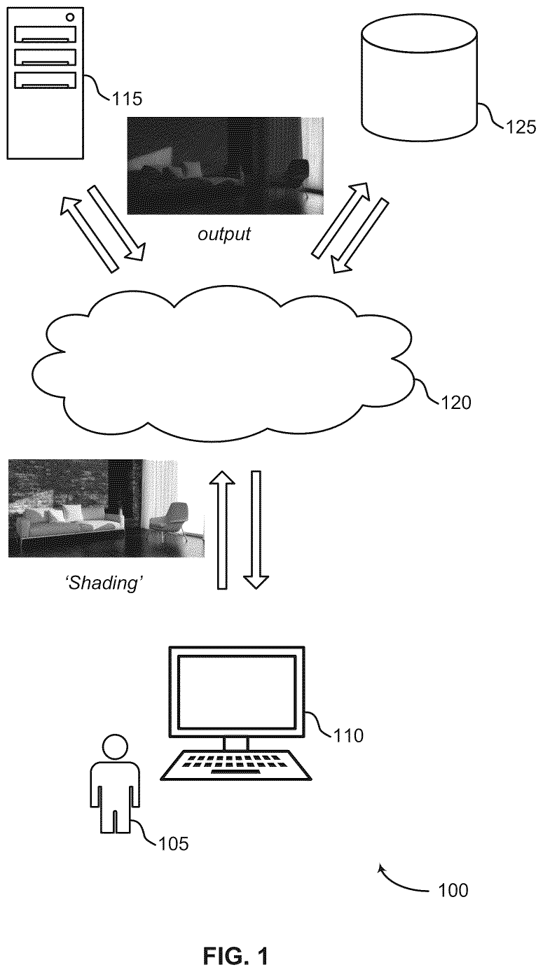

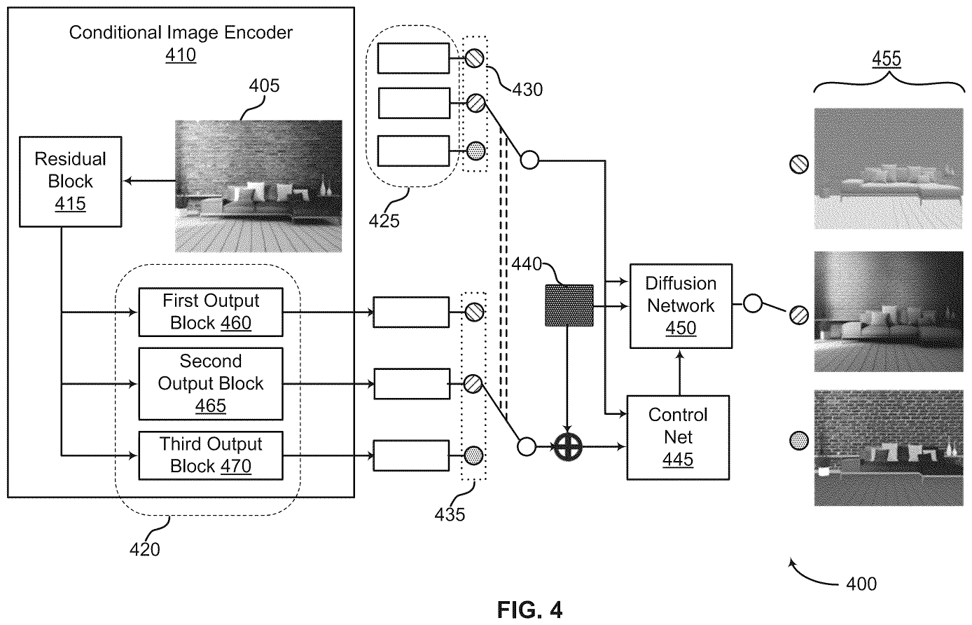

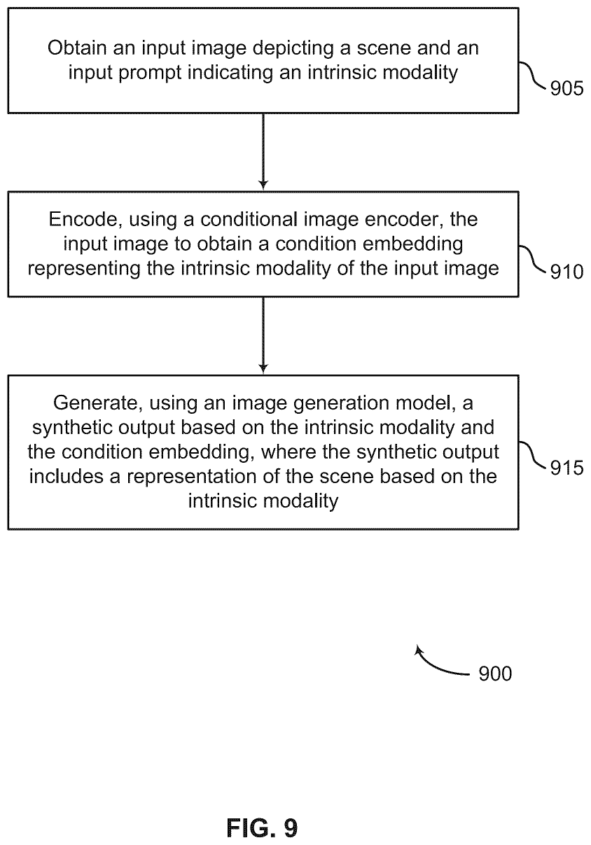

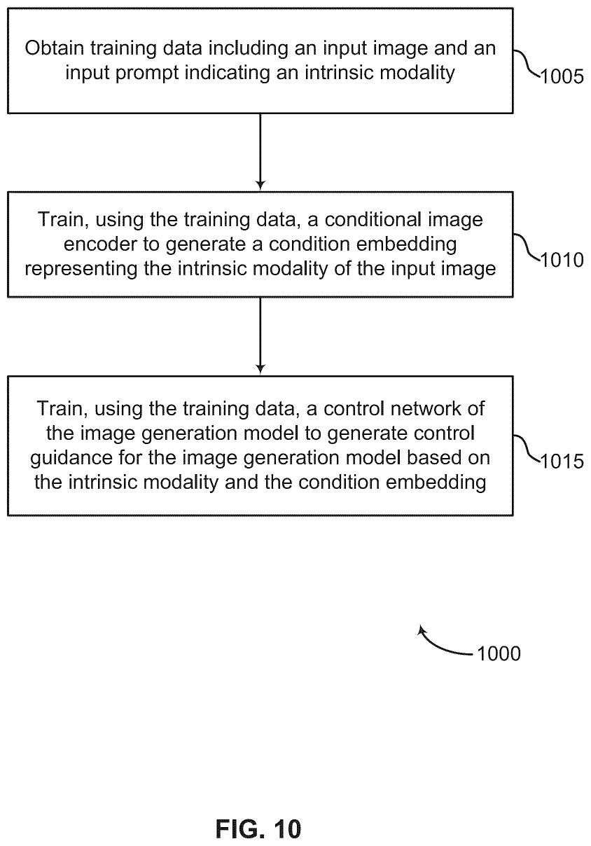

Embodiments of the present disclosure can be implemented in an image generation model. For example, the image generation model based on the present disclosure takes an input image (e.g., depicting a scene) and accurately generates an output that depicts an intrinsic modality of the input image. Example applications regarding generating an output that depicts a scene are provided with reference to FIGS. 1-3. Details regarding the architecture of the image generation model are provided with reference to FIGS. 4-8 and 13-15. Details regarding a process of operation of the image generation model are provided with reference to FIG. 9. Examples of a process for training the image generation model are provided with reference to FIGS. 10-12.

### Image Generation System

A system and an apparatus for image processing are described with reference to FIGS. 1-8. FIG. 1 shows an example of an image processing system 100 according to aspects of the present disclosure. In one aspect, image processing system 100 includes user 105, user device 110, image processing apparatus 115, cloud 120, and database 125.

In the example of FIG. 1, user 105 provides an image depicting a scene to image processing apparatus 115 via a user interface provided on user device 110 by image processing apparatus 115. In some cases, the input prompt is an input text. As used herein, the input text indicates an intrinsic modality that the user wants to depict in a generated output. As an example shown in FIG. 1, the user provides an input text that describes the intrinsic modality the user wants to generate using the image processing apparatus 115 of the present disclosure. According to some aspects, image processing apparatus 115 obtains an input prompt, i.e., indication of an intrinsic modality (e.g., “shading”).

In some cases, the image processing apparatus 115 implements an image generation model (such as the image generation model described with reference to FIG. 4) to generate a synthetic output that modifies the input image based on the input prompt. In some cases, as shown in FIG. 1, the user provides an input prompt (e.g., a text prompt) to the image processing apparatus 115, aspects of which the user wants to depict in the synthetic output. In some examples, the image processing apparatus generates a synthetic output that accurately modifies the scene of the input image to match the intrinsic modality provided by the input prompt. For example, as shown in FIG. 1, the image processing apparatus generates an output (i.e., a synthetic output) that depicts shading of the scene in the input image.

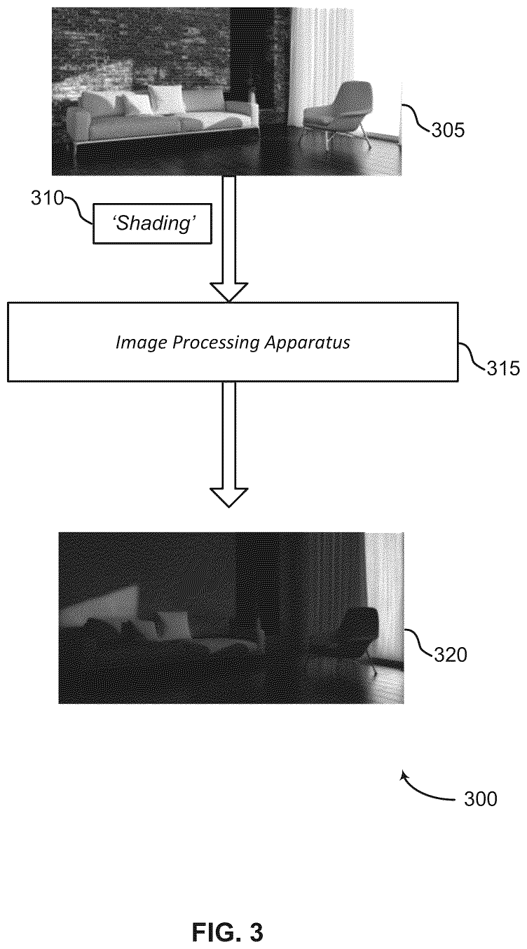

Referring to the example of FIG. 1, the image processing apparatus 115 provides the synthetic output to user 105 via the user interface provided on user device 110. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image processing apparatus 115. In some aspects, the user interface provides for information (such as images (custom images or synthetic image), a prompt, etc.) to be communicated between user 105 and image processing apparatus 115. Image processing apparatus 115 is an example of, or includes aspects of, the corresponding element described with reference to FIGS. 3-4 and 14.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

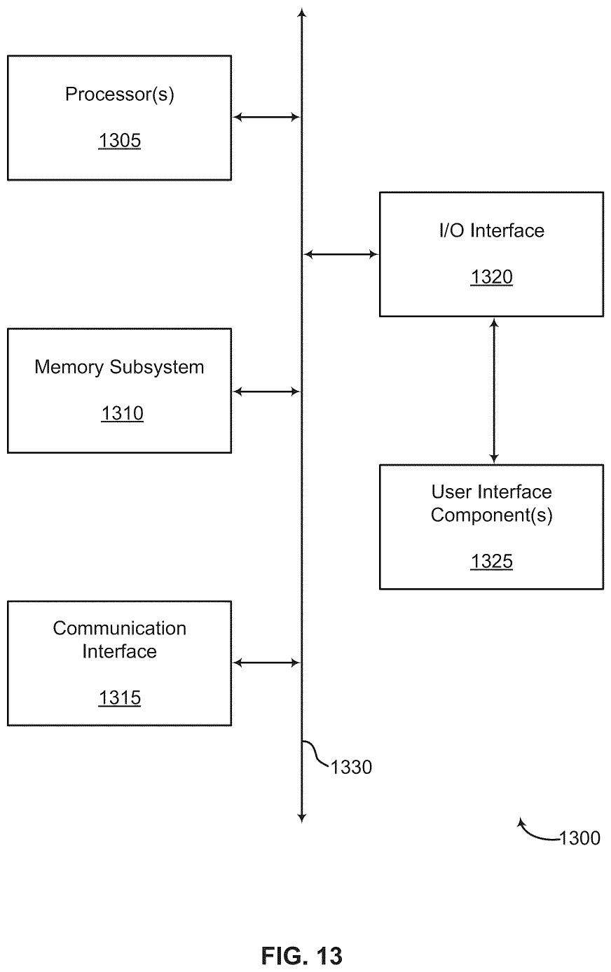

According to some aspects, image processing apparatus 115 includes a computer-implemented network. In some embodiments, the computer-implemented network includes a machine learning model (such as the machine learning model described with reference to FIGS. 4-8). In some embodiments, image processing apparatus 115 also includes one or more processors, a memory subsystem, a communication interface, an I/O interface, one or more user interface components, and a bus as described with reference to FIG. 13. Additionally, in some embodiments, image processing apparatus 115 communicates with user device 110 and database 125 via cloud 120.

In some cases, image processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, image processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image processing apparatus 115 and communicates with image processing apparatus 115 via cloud 120. According to some aspects, database 125 is included in image processing apparatus 115.

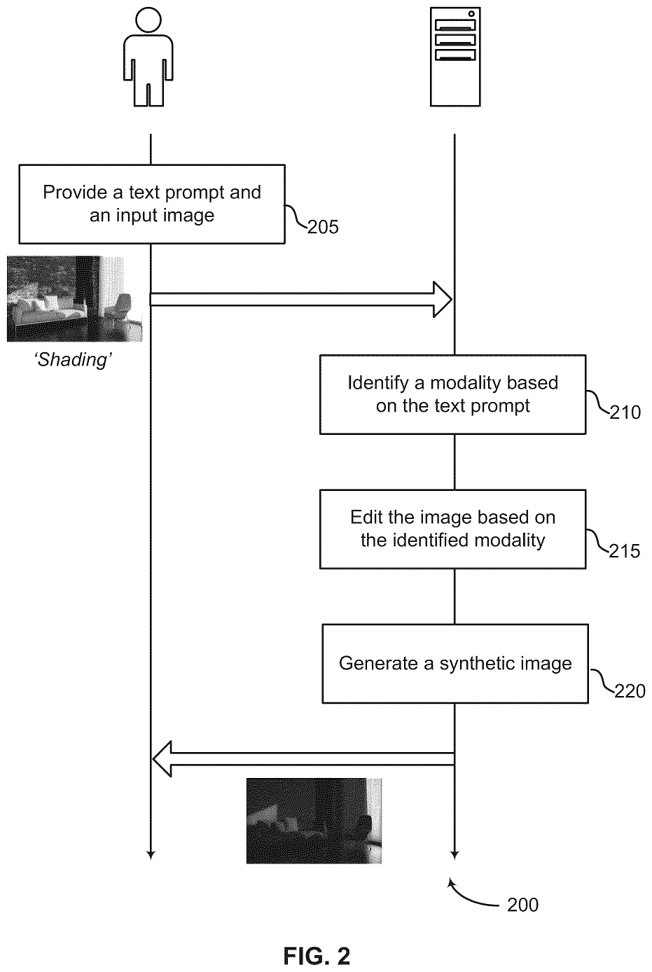

FIG. 2 shows an example of a method 200 for generating an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

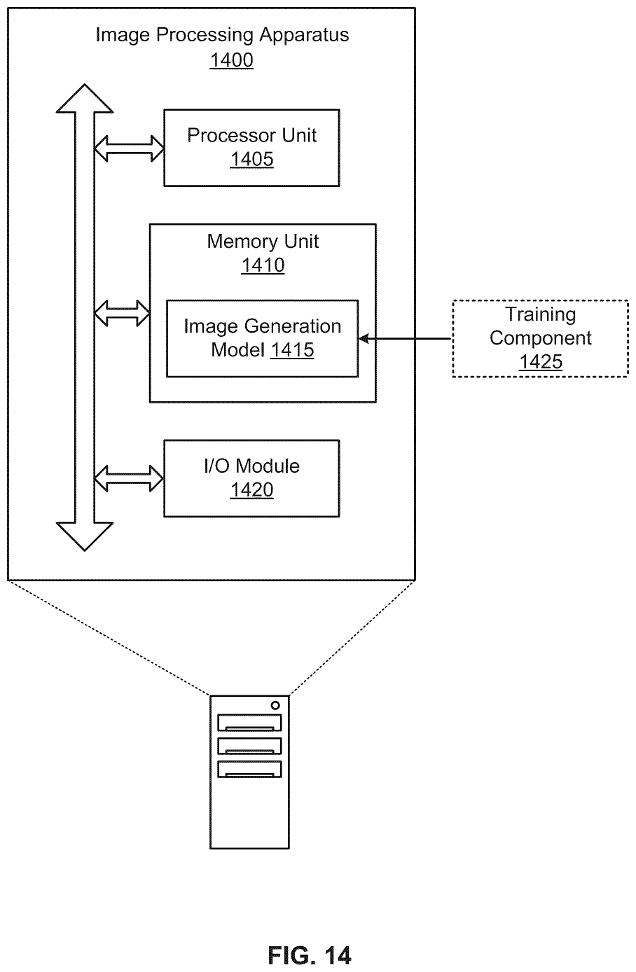

According to an embodiment of the present disclosure, an image processing apparatus (such as the image processing apparatus described with reference to FIGS. 3 and 14) provides a machine learning model (such as the image generation model described with reference to FIGS. 4-8 and 14-15) that accurately generates a synthetic output depicting the intrinsic modality described in the input text prompt as being incorporated into the scene of the input image.

At operation 205, the system provides a text prompt and an input image. In some cases, the operations of this step refer to, or may be performed by, a user as described with reference to FIG. 1.

In some examples, the user provides a text prompt to the image processing apparatus (such as the image processing apparatus described with reference to FIG. 1). As shown in FIG. 2, the text prompt describes an intrinsic modality that the user wants to depict in the input image. For example, the user wants the generated image (i.e., synthetic output) to depict a “shaded” scene of the input image as specified in the text prompt. In some cases, the user provides the text prompt to the image processing apparatus via a user interface (such as a graphical user interface) provided on a user device by the image processing apparatus.

At operation 210, the system identifies a modality based on the text prompt. In some cases, the operations of this step refer to, or may be performed by, an image processing apparatus as described with reference to FIGS. 1, 3-4 and 14. In some cases, the image processing apparatus identifies an intrinsic modality (e.g., shading, albedo, normal, etc.) provided in the text prompt. In some examples, the image processing apparatus implements a control guidance on a diffusion model based on the identified modality. Further details regarding this operation are provided with reference to at least FIG. 4.

As described herein, the intrinsic modality of an image refers to a fundamental component or characteristic of the image that describes how the image is formed based on the physical properties of the scene. For example, the intrinsic modality represents different aspects of an image formation based on the interaction of light with surfaces in the scene. In some examples, intrinsic modalities such as shading, albedo, or normal, refer to the intrinsic components or properties of an image that describe the physical characteristics of the image.

According to an embodiment, “shading” refers to the variation in intensity or color in an image due to the way light interacts with the surface geometry of objects. In some examples, shading is a result of light illuminating an object, considering factors such as the angle of incidence, presence of shadows, etc. For example, shading provides cues regarding the shape and contours of objects in the image.

According to an embodiment, “albedo” represents the intrinsic color or brightness of a surface, independent of lighting conditions. In some cases, albedo or texture refers to a property that describes the amount of light a surface reflects diffusely. For example, the albedo or texture of the image refers to aspects of the image that are seen if the image is evenly lit (e.g., from all directions) without any shading effects.

According to an embodiment, “normal” refers to the surface normal vectors at each point on an object in the scene. In some cases, a normal vector is perpendicular to the surface at a given point and indicates the direction the surface is facing. For instance, as described, the direction is represented in world-space (i.e., not camera space). In case of images, normal maps are used to encode the said information that provides an understanding of the 3D structure of objects. In some cases, normal maps are used for tasks such as relighting, where the interaction of light with the surface is simulated under different conditions.

At operation 215, the system edits the image based on the identified modality. In some cases, the operations of this step refer to, or may be performed by, an image processing apparatus as described with reference to FIGS. 1, 3-4 and 14.

According to an embodiment of the present disclosure, the image processing apparatus generates a condition vector corresponding to the identified intrinsic modality. In some cases, the image processing apparatus includes a condition image encoder (such as the condition image encoder described with reference to FIG. 4) comprising a plurality of residual blocks and a transformer network that may be configured to generate the condition vector.

In some examples, the image processing apparatus implements a control network (such as the control network described with reference to FIG. 4) that generates a control guidance based on the condition vector (e.g., selected condition vector that corresponds to the identified modality). Additionally, a result of the control network is used to guide generation of the synthetic image based on a diffusion model (such as the diffusion model described with reference to FIGS. 4 and 6-8).

That is, as shown in FIG. 2, at operation 220, the system generates the synthetic image. In some cases, the operations of this step refer to, or may be performed by, an image processing apparatus as described with reference to FIGS. 1, 3-4, and 14. In some cases, the image processing apparatus of the present disclosure is able to predict an image with a desired intrinsic modality based on an input image.

Embodiments of the present disclosure are configured to jointly predict albedo, shading, and surface normal layers from an input (e.g., a single) image (e.g., using processes described with reference to at least FIG. 4). For example, the image processing apparatus is, thus, able to accurately generate a synthetic output by incorporating aspects of the input prompt (e.g., shading) into the input image. For example, in some cases, the image processing apparatus displays the synthetic image to the user via the user interface (such as the user interface described with reference to FIG. 1).

In some cases, the synthetic image depicts a shaded scene, i.e., the synthetic image depicts a shading on the scene of the input image. In some examples, the synthetic image is used for editing tasks, such as image relighting and retexturing. Additionally, embodiments are not necessarily limited thereto and in some exemplary cases, the user provides an input image (e.g., depicting a scene) and an input prompt (e.g., “albedo”, “normal”, etc.) and the image processing apparatus accurately generates a synthetic output corresponding to the (e.g., “albedo”, “normal”) input prompt.

FIG. 3 shows an example of an image generation process 300 according to aspects of the present disclosure. In one aspect, image generation process 300 includes input image 305, input prompt 310, image processing apparatus 315, and decomposed image 320.

Referring to FIG. 3, input image 305 depicts a scene a user wants to modify based on input prompt 310. In some cases, input prompt 310 specifies an intrinsic modality that the user wants the decomposed image 320 (such as synthetic image or synthetic output described with reference to FIGS. 2 and 4) to depict. For instance, the input prompt 310 specifies the intrinsic modality as “shading”. Input image 305 is an example of, or includes aspects of, the corresponding element described with reference to FIG. 4. Input prompt 310 is an example of, or includes aspects of, the corresponding element described with reference to FIG. 4.

The image processing apparatus 315 (such as the image processing apparatus described with reference to FIGS. 1-2, 4, and 14-15) of the present disclosure receives the input image 305 and input prompt 310 from the user. In some cases, the image processing apparatus 315 modifies the input image 305 to generate decomposed image 320 that matches aspects of the input prompt 310. For instance, the image processing apparatus 315 generates decomposed image 320 that depicts the intrinsic layer (i.e., shading) based on the input prompt 310. Decomposed image 320 is an example of, or includes aspects of, the synthetic image or synthetic output described with reference to FIGS. 1-2 and 4.

Embodiments of the present disclosure include an image generation model that is configured to implicitly learn intrinsic image priors based on model training. Additionally, embodiments include a conditioning mechanism that guides a pre-trained image generation model to jointly predict multiple intrinsic modalities from an input image. In some cases, the joint or collaborative predicting of the different modalities provides for an improvement of the overall generation quality of the synthetic output. In some cases, embodiments are able to enable mixing of datasets with annotations of only a subset of the modalities during training, which contributes to the generalizability of the method. In some examples, downstream image editing applications, such as relighting and retexturing, may be performed on the synthetic output generated by the image processing apparatus.

As described herein, intrinsic layers of an image reveal inherent properties of a scene. For instance, an intrinsic decomposition of an image is represented as the reflectivity of the surfaces depicted in the image (i.e., albedo layer), the interaction between the light and the surfaces (i.e., shading layer), and the direct underlying surface geometry (i.e., normal layer). In some cases, understanding such properties from an image is used for editing tasks, such as relighting, retexturing, and realistic image composition.

According to an embodiment, a control network is used to guide the image generation model for performing the intrinsic image decomposition. In some cases, the control network takes an input image and efficiently generates the corresponding intrinsic layers, i.e., albedo, shading, and surface normal layers. For example, the control network is jointly implemented for each of the said layers, e.g., the joint control branch adapts to each of the said modalities based on the different prompts provided as input (e.g., albedo, shading, and surface normal).

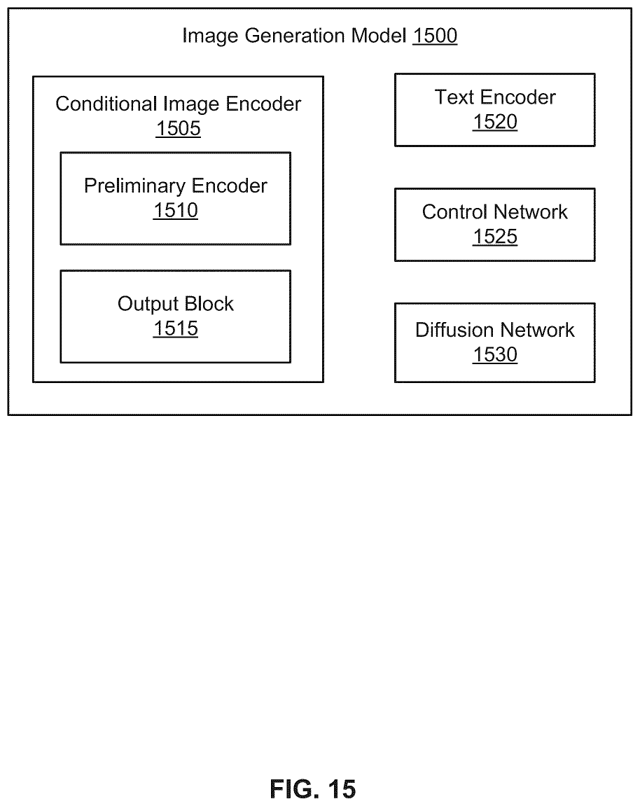

FIG. 4 shows an example of an image generation model 400 according to aspects of the present disclosure. Image generation model 400 is an example of, or includes aspects of, the corresponding element described with reference to FIGS. 14 and 15.

In one aspect, image generation model 400 includes input image 405, conditional image encoder 410, text prompt 425, text embedding 430, condition vector 435, noise map 440, control network 445, diffusion network 450, and synthetic output 455.

Embodiments of the present disclosure are configured to generate an intrinsic layer based on an input image. In some cases, the image generation model 400 takes input image 405 and an input prompt (such as text prompt 425 indicating at least one of albedo, shading, and surface normal modalities) and efficiently generates a corresponding intrinsic layer (such as synthetic output 455 comprising albedo layer, shading layer, and surface normal layer). Input image 405 is an example of, or includes aspects of, the corresponding element described with reference to FIG. 3.

In some cases, given an input image I (i.e., input image 405), the image generation model 400 generates an albedo layer A∈ [symbol] ^{W×H×3}, a color shading layer S∈ [symbol] ^{W×H×3}, and a surface normal map N∈ [symbol] ^{W×H×3}. The image generation model, via conditional image encoder 410, extracts embedding features from the input image 405 (I) and maps the said features to domain-specific embedding vectors that are used as conditioning input for a conditional latent diffusion model via control network 445.

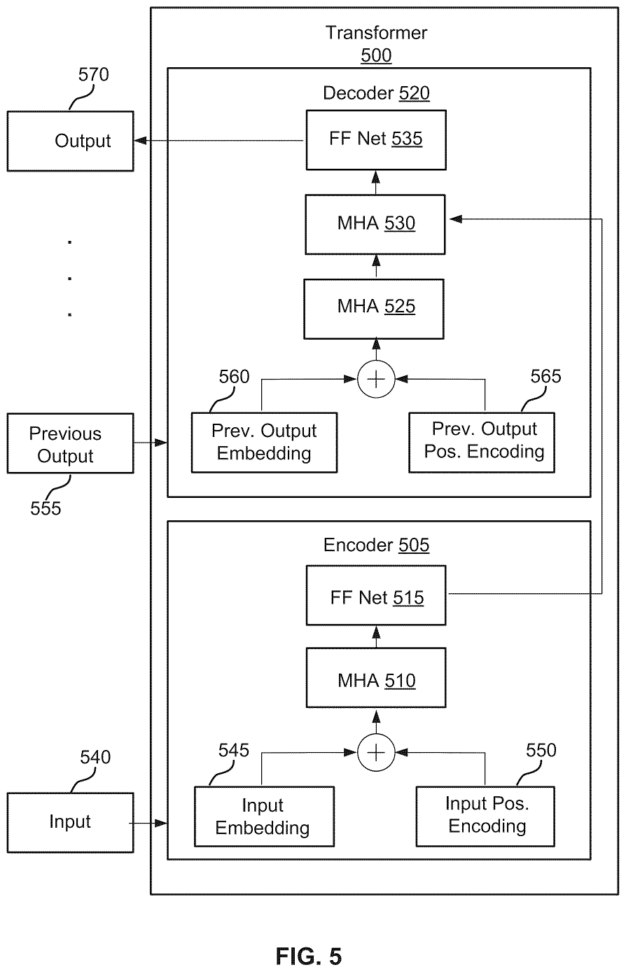

In one aspect, conditional image encoder 410 includes residual block 415 and transformer network 420. In some cases, by jointly learning a set of shared residual blocks and domain-specific transformers for feature embedding and simultaneously using domain-specific text prompts to condition the control network, embodiments of the present disclosure are able to adapt the image generation model to different intrinsic modalities (e.g., albedo, shading, and surface normal). Transformer network 420 is an example of, or includes aspects of, the corresponding element described with reference to FIG. 5.

According to an embodiment, control network 445 is implemented as a ControlNet. ControlNet is a neural network structure to control image generation models by adding extra conditions. In some embodiments, a ControlNet architecture copies the weights from some of the neural network blocks of the image generation model to create a “locked” copy and a “trainable” copy. The “trainable” one learns your condition. The “locked” copy preserve the parameters of the original model. The trainable copy can be tuned with a small dataset of image pairs, while preserving the locked copy ensures that original model is preserved.

In some embodiments, one or more zero convolution layers are added to the trainable copy. A “zero convolution” layer is 1×1 convolution with both weight and bias initialized as zeros. Before training, the zero convolution layers output all zeros. Accordingly, the ControlNet will not cause any distortion. As the training proceeds, the parameters of the zero convolution layers deviate from zero and the influence of the ControlNet on the output grows.

For example, a ControlNet architecture can be used to control a diffusion U-Net (i.e., to add controllable parameters or inputs that influence the output). Encoder layers of the U-Net can be copied and tuned. Then zero convolution layers can be added. In some examples, the output of the control network is input to decoder layers of the U-Net.

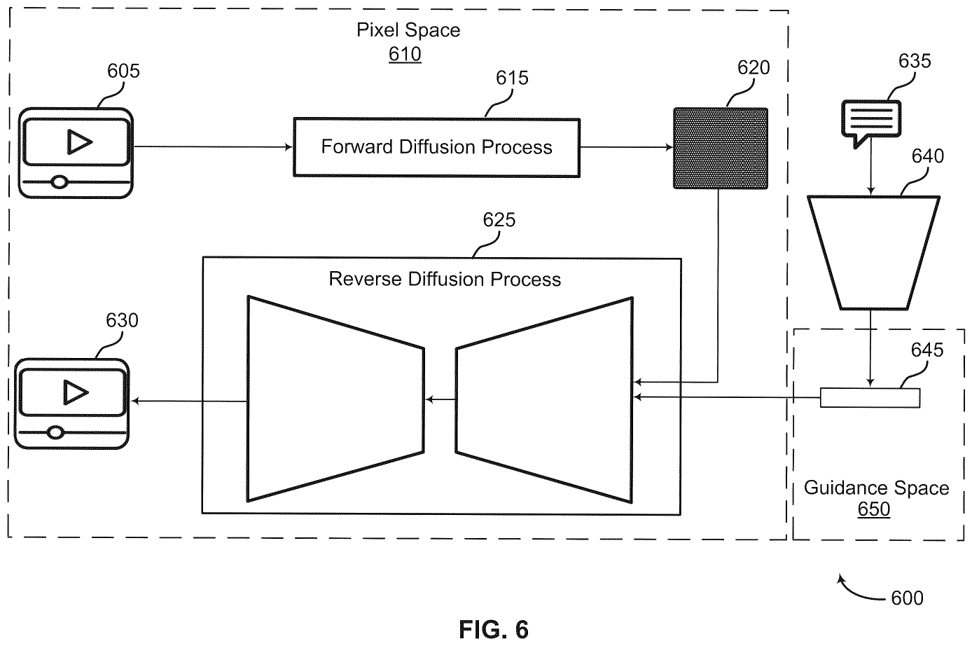

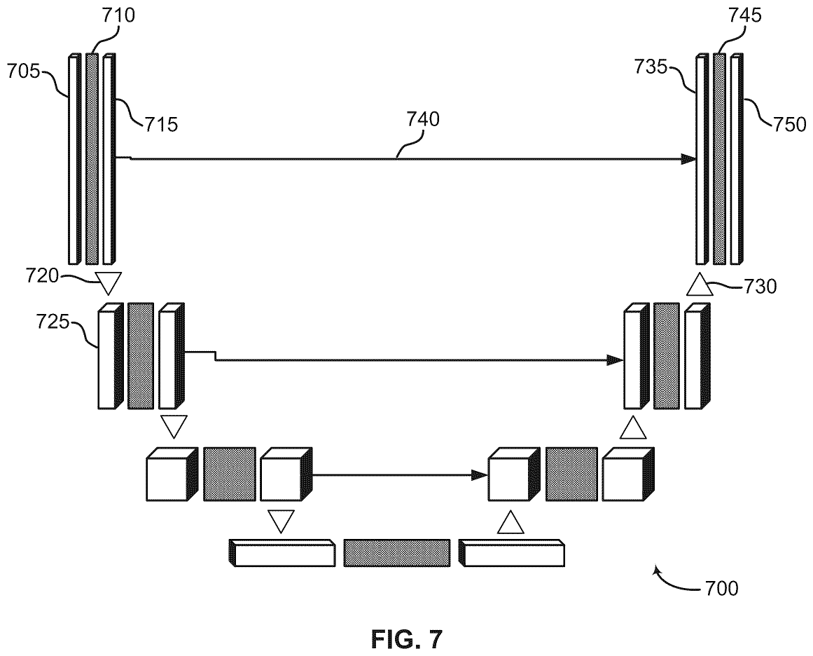

Diffusion network (such as diffusion network 600 described with reference to FIG. 6) consists of a forward and a backward process. The forward process adds Gaussian noise to the data to gradually remove information. In latent diffusion models, the data is first mapped to a latent space via a variational autoencoder as:

$${z}_{t} = \sqrt{{\overline{α}}_{t}} {z}_{0} + \sqrt{1 - {\overline{α}}_{t}} ϵ \qquad ( 1 )$$

where ϵ˜ [symbol] (0, I) is the Gaussian noise, z₀ is the clean data in the latent space, zₜ is the noisy latent feature at time step t, and āₜ is computed from a fixed variance schedule. Additionally, during the backward process, a U-Net ϵ_{θ}(·) (such as the U-Net 700 described with reference to FIG. 7) is trained to restore information by predicting the noise at a time step t, with a loss of:

$$ℒ = {𝔼}_{{z}_{0} , ϵ \sim 𝒩 , t} [ {‖ ϵ - {ϵ}_{θ} ( {z}_{t} , t ) ‖}_{2}^{2} ] \qquad ( 2 )$$

In some cases, a cross-attention layer is implemented in the U-Net to combine a control signal τθ(y) with the intermediate layers of the U-Net to control the generation. Here, y is set to be a prompt embedding and τ_{θ}(·) is a trainable encoder. The generative latent diffusion model is trained with the loss:

$$ℒ = {𝔼}_{{z}_{0} , y , ϵ \sim 𝒩 , t} [ {‖ ϵ - {ϵ}_{θ} ( {z}_{t} , t , {τ}_{θ} ( y ) ) ‖}_{2}^{2} ] \qquad ( 3 )$$

According to an embodiment of the present disclosure, the diffusion network is adapted to a conditional task using a control branch (e.g., via control network 445). The control network 445 (e.g., a ControlNet) enables preservation of the quality and capabilities of the base model by locking the parameters. For instance, the control network 445 is a trainable copy of the U-Net encoding layers from the base diffusion model (such as diffusion model 600 described in FIG. 6). In some examples, the control network 445 is connected to the base diffusion model with zero convolution layers. The image generation process is optimized via:

$$ℒ = {𝔼}_{{z}_{0} , y , ϵ \sim 𝒩 , t , {c}_{I}} [ {‖ ϵ - {ϵ}_{θ} ( {z}_{t} , t , {τ}_{θ} ( y ) , {c}_{I} ) ‖}_{2}^{2} ] \qquad ( 4 )$$

where c_{I} is the encoded control image.

An embodiment of the present disclosure includes a conditional image encoder configured to extract dense features from the condition image without losing spatially matched details. As shown in FIG. 4, conditional image encoder 410 includes a sequence of residual blocks 415 followed by a transformer network 420 to generate feature-space conditioning vectors from input image 405 (e.g., input RGB image). In one aspect, the transformer network 420 includes a first output block 460, a second output block 465, and a third output block 470. For instance, each of the first output block 460, the second output block 465, and the third output block 470 are SwinV2 transformer layers.

According to an example, conditional image encoder 410 includes eight shared layers of residual blocks 415 R(·), that map I∈ [symbol] ^{W×H×3} into

$$R ( I ) ∈ {ℝ}^{\frac{W}{8} \times \frac{H}{8} \times 320} .$$

The shared layers are followed by a domain-specific transformer T_{*}(·) (i.e., first output block 460, second output block 465, and third output block 470) applied to R(I), where ‘*’ refers to one of the intrinsic domains. The output of the conditional image encoder, i.e., condition vector

$$435 , {c}_{I}^{*} = {T}_{*} R ( I ) )$$

is used as a condition for the control network 445. Further details regarding the transformer network are provided with reference to FIG. 5.

The control network 445 is trained by combining data for different modalities (i.e., one of condition vector 435) with the corresponding text embedding 430. For example, the name of the modality (e.g., “Shading”, “Albedo”, or “Surface Normal”) is used as the text prompt. In some examples, a text encoder (such as text encoder 1520 described in FIG. 15) encodes the text prompt to generate a corresponding text embedding 430. In some examples, the prompt is fixed and modality-specific. The diffusion model 450 and the control network 445 are trained to generate different intrinsic modalities based on the condition vector 435 and the corresponding text embedding 430 (i.e., albedo, shading, and surface normal as shown in FIG. 4). Further details regarding the diffusion network are provided with reference to FIGS. 6-8. Further details regarding training the diffusion network and the control network are provided with reference to FIG. 10.

FIG. 5 shows an example of a transformer network 500 according to aspects of the present disclosure. The example shown includes transformer 500, encoder 505, decoder 520, input 540, input embedding 545, input positional encoding 550, previous output 555, previous output embedding 560, previous output positional encoding 565, and output 570. According to some aspects, encoder 505 is implemented as a text encoder of a multi-modal encoder (such as the text encoder 1520 described with reference to FIG. 15). According to some aspects, encoder 505 is implemented as an image encoder of conditional image encoder (such as the conditional image encoder 410 described with reference to FIG. 4). According to some aspects, transformer 500 is implemented in the conditional image encoder (such as the conditional image encoder described with reference to FIG. 4). According to some aspects, transformer 500 is implemented in an image conditioning network.

In some cases, encoder 505 includes multi-head self-attention sublayer 510 and feed-forward network sublayer 515. In some cases, decoder 520 includes first multi-head self-attention sublayer 525, second multi-head self-attention sublayer 530, and feed-forward network sublayer 535.

In some cases, encoder 505 is configured to map input 540 (for example, a text prompt) to a sequence of continuous representations that are fed into decoder 520. In some cases, decoder 520 generates output 570 (e.g., a prediction of an output sequence of words or tokens) based on the output of encoder 505 and previous output 555 (e.g., a previously predicted output sequence), which allows for the use of autoregression.

For example, in some cases, encoder 505 parses input 540 into tokens and vectorizes the parsed tokens to obtain input embedding 545, and adds input positional encoding 550 (e.g., positional encoding vectors for input 540 of a same dimension as input embedding 545) to input embedding 545. In some cases, input positional encoding 550 includes information about relative positions of words or tokens in input 540.

In some cases, encoder 505 comprises one or more encoding layers that generate contextualized token representations, where each representation corresponds to a token that combines information from other input tokens via self-attention mechanism. In some cases, each encoding layer of encoder 505 comprises a multi-head self-attention sublayer (e.g., multi-head self-attention sublayer 510). In some cases, the multi-head self-attention sublayer implements a multi-head self-attention mechanism that receives different linearly projected versions of queries, keys, and values to produce outputs in parallel. In some cases, each encoding layer of encoder 505 also includes a fully connected feed-forward network sublayer (e.g., feed-forward network sublayer 515) comprising two linear transformations surrounding a Rectified Linear Unit (ReLU) activation:

$$FFN ( x ) = ReLU ( {W}_{1} x + {b}_{1} ) {W}_{2} + {b}_{2} \qquad ( 5 )$$

In some cases, each layer employs different weight parameters (W₁, W₂) and different bias parameters (b₁, b₂) to apply a same linear transformation each word or token in input 540.

In some cases, each sublayer of encoder 505 is followed by a normalization layer that normalizes a sum computed between a sublayer input x and an output sublayer(x) generated by the sublayer:

$$layernorm ( x + sublayer ( x ) ) \qquad ( 6 )$$

In some cases, encoder 505 is bidirectional because encoder 505 attends to each word or token in input 540 regardless of a position of the word or token in input 540.

According to some aspects, encoder 505 functions as an image encoder of the conditional image encoder (such as the conditional image encoder 410 described with reference to FIG. 4). In an example, conditional image encoder splits an input image into fixed-size patches, generates a linear embedding of each of the patches, adds position embeddings to each of the linear embeddings, and provides the resulting sequence of vectors as input 540 to encoder 505.

In some cases, decoder 520 comprises one or more decoding layers (e.g., six decoding layers). In some cases, each decoding layer comprises three sublayers including a first multi-head self-attention sublayer (e.g., first multi-head self-attention sublayer 525), a second multi-head self-attention sublayer (e.g., second multi-head self-attention sublayer 530), and a feed-forward network sublayer (e.g., feed-forward network sublayer 535). In some cases, each sublayer of decoder 520 is followed by a normalization layer that normalizes a sum computed between a sublayer input x and an output sublayer(x) generated by the sublayer.

In some cases, decoder 520 generates previous output embedding 560 of previous output 555 and adds previous output positional encoding 565 (e.g., position information for words or tokens in previous output 555) to previous output embedding 560. In some cases, each first multi-head self-attention sublayer receives the combination of previous output embedding 560 and previous output positional encoding 565 and applies a multi-head self-attention mechanism to the combination. In some cases, for each word in an input sequence, each first multi-head self-attention sublayer of decoder 520 attends only to words preceding the word in the sequence, and so a prediction of transformer 500 for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 505 by receiving a query Q from a previous sublayer of decoder 520 and a key K and a value V from the output of encoder 505, allowing decoder 520 to attend to each word in the input 540.

In some cases, each feed-forward network sublayer implements a fully connected feed-forward network similar to feed-forward network sublayer 515. In some cases, the feed-forward network sublayers are followed by a linear transformation and a softmax to generate a prediction of output 570.

FIG. 6 shows an example of a guided diffusion model 600 according to aspects of the present disclosure. In some examples, guided diffusion model 600 describes the operation and architecture of the image generation model 1415 described with reference to FIG. 14 or image generation model 1500 described with reference to FIG. 15. The guided latent diffusion model 600 depicted in FIG. 6 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 600 may take an original media item 605 in a pixel space 610 as input and apply forward diffusion process 615 to gradually add noise to the original media item 605 to obtain noisy media item 620 at various noise levels.

Next, a reverse diffusion process 625 (e.g., a U-Net) gradually removes the noise from the noisy media item 620 at the various noise levels to obtain an output media item 630. In some cases, an output media item 630 is created from each of the various noise levels. The output media item 630 can be compared to the original media item 605 to train the reverse diffusion process 625.

The reverse diffusion process 625 can also be guided based on a text prompt 635, or another guidance prompt, such as an image, a layout, a segmentation map, etc. The text prompt 635 can be encoded using a text encoder 665 (e.g., a multimodal encoder) to obtain guidance features 645 in guidance space 650. The guidance features 645 can be combined with the noisy media item 620 at one or more layers of the reverse diffusion process 625 to ensure that the output media item 630 includes content described by the text prompt 635. For example, guidance features 645 can be combined with the noisy features using a cross-attention block within the reverse diffusion process 625.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item. DDIM is an example of, or includes aspects of, the corresponding element described with reference to FIGS. 4 and 14-15.

FIG. 7 shows an example of a U-Net 700 according to aspects of the present disclosure. In some examples, U-Net 700 is an example of the component that performs the reverse diffusion process 625 of guided diffusion model 600 described with reference to FIG. 6 and includes architectural elements of the image generation model 1415 described with reference to FIG. 14 or image generation model 1500 described with reference to FIG. 15. The U-Net 700 depicted in FIG. 7 is an example of, or includes aspects of, the architecture used within the reverse diffusion process described with reference to FIG. 6.

In some examples, diffusion models are based on a neural network architecture known as a U-Net. The U-Net 700 takes input features 705 having an initial resolution and an initial number of channels and processes the input features 705 using an initial neural network layer 710 (e.g., a convolutional network layer) to produce intermediate features 715. The intermediate features 715 are then down-sampled using a down-sampling layer 720 such that down-sampled features 725 features have a resolution less than the initial resolution and a number of channels greater than the initial number of channels.

This process is repeated multiple times, and then the process is reversed. That is, the down-sampled features 725 are up-sampled using up-sampling process 730 to obtain up-sampled features 735. The up-sampled features 735 can be combined with intermediate features 715 having the same resolution and number of channels via a skip connection 740. These inputs are processed using a final neural network layer 745 to produce output features 750. In some cases, the output features 750 have the same resolution as the initial resolution and the same number of channels as the initial number of channels.

In some cases, U-Net 700 takes additional input features to produce conditionally generated output. For example, the additional input features could include a vector representation of an input prompt. The additional input features can be combined with the intermediate features 715 within the neural network at one or more layers. For example, a cross-attention module can be used to combine the additional input features and the intermediate features 715. U-Net architecture is an example of, or includes aspects of, the corresponding element described with reference to FIGS. 4 and 6.

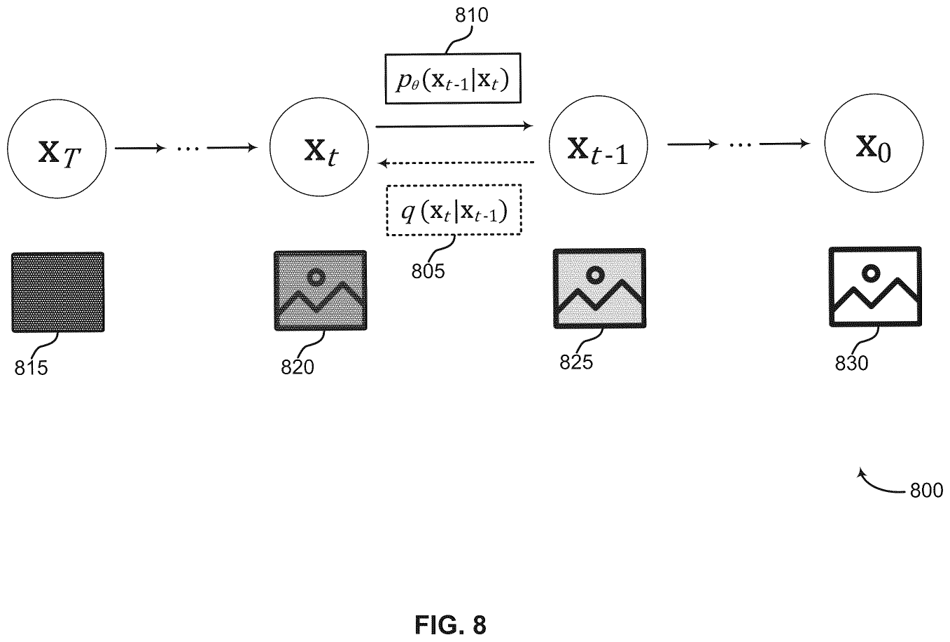

FIG. 8 shows a diffusion process 800 according to aspects of the present disclosure. In some examples, diffusion process 800 describes an operation of the image generation model 1415 described with reference to FIG. 14 or image generation model 1500 described with reference to FIG. 15, such as the reverse diffusion process 625 of guided diffusion model 600 described with reference to FIG. 6.

As described above with reference to FIG. 6, using a diffusion model can involve both a forward diffusion process 805 for adding noise to a media item (or features in a latent space) and a reverse diffusion process 810 for denoising the media item (or features) to obtain a denoised media item. The forward diffusion process 805 can be represented as q(xₜ|xₜ₋₁), and the reverse diffusion process 810 can be represented as p(xₜ₋₁|xₜ). In some cases, the forward diffusion process 805 is used during training to generate media items with successively greater noise, and a neural network is trained to perform the reverse diffusion process 810 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 810, the model begins with noisy data x_{T}, such as a noisy media item 815 and denoises the data to obtain the p(xₜ₋₁|xₜ). At each step t−1, the reverse diffusion process 810 takes xₜ, such as first intermediate media item 820, and t as input. Here, t represents a step in the sequence of transitions associated with different noise levels, The reverse diffusion process 810 outputs xₜ₋₁, such as second intermediate media item 825 iteratively until x_{T} reverts back to x₀, the original media item 830. The reverse process can be represented as:

$${p}_{θ} ( {x}_{t - 1} \vert {x}_{t} ) \text{:=} N ( {x}_{t - 1} ; {μ}_{θ} ( {x}_{t} , t ) , {\sum }_{θ} ( {x}_{t} , t ) ) \qquad ( 7 )$$

The joint probability of a sequence of samples in the Markov chain can be written as a product of conditionals and the marginal probability:

$${x}_{T} \text{:} {p}_{θ} ( {x}_{0 : T} ) ) \text{:=} p ( {x}_{T} ) {\prod }_{t = 1}^{T} {p}_{θ} ( {x}_{t - 1} \vert {x}_{t} ) \qquad ( 8 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality. Diffusion process is an example of, or includes aspects of, the corresponding element described with reference to FIGS. 2, 4, 5, and 10-12.

Accordingly, an apparatus for image generation is described. One or more aspects of the apparatus include a memory component; a processing device coupled to the memory component, the processing device configured to perform operations comprising: obtaining an input image depicting a scene and an input prompt indicating an intrinsic modality; encoding, using a conditional image encoder, the input image to obtain a condition embedding representing the intrinsic modality of the input image; and generating, using an image generation model, a synthetic output based on the intrinsic modality and the condition embedding, wherein the synthetic output comprises a representation of the scene based on the intrinsic modality.

In some aspects, the conditional image encoder comprises a plurality of output blocks corresponding to a plurality of intrinsic modalities, respectively. In some aspects, the conditional image encoder comprises a preliminary encoder trained to provide a preliminary condition embedding to each of the plurality of output blocks.

In some aspects, each of the plurality of output blocks comprises a transformer network. In some aspects, the image generation model comprises a diffusion network. In some aspects, the control network comprises a ControlNet architecture.

### Image Generation Process

The present disclosure describes systems and methods for image generation. Embodiments of the present disclosure include an image generation model comprising a conditional image encoder and a control network configured to guide a diffusion model. In some cases, the conditional image encoder comprises a sequence of residual blocks and a plurality of transformer layers. In some cases, the image generation model is configured to generate a corresponding intrinsic layer (i.e., albedo, shading, and surface normal) based on an RGB image taken as input.

In some cases, the image generation model enables joint training of the control network. In some cases, the image generation model enables learning based on an effective latent space, where the prediction of one modality (e.g. shading) enables an improvement of the prediction of other modalities (e.g., albedo and surface normal).

The image generation model of the present disclosure is configured to perform intrinsic image decomposition as a conditional generation that leverages a pre-trained text-to-image model (e.g., a base diffusion model). In some cases, the image generation model includes a control network that jointly predicts multiple intrinsic modalities (e.g., shading, albedo, and surface normal). Accordingly, by implementing a control network that includes an ability to combine different data sources with different types of annotations using a joint learning framework, embodiments of the present disclosure are able to enhance the overall performance of the intrinsic image decomposition system.

FIG. 9 shows an example of a method 900 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Embodiments of the present disclosure are configured to perform an intrinsic image decomposition for an editing application based on an input image. For example, the decomposed image is used for applications such as relighting, retexturing, etc. An embodiment of the present disclosure includes an image generation model comprising extracting intrinsic information of an input RGB image via the conditional image encoder that jointly predicts multiple modalities. The control network captures a condition vector of a modality and the corresponding text embedding to guide an output of the diffusion model (e.g., during the denoising process).

For example, the control network captures a text embedding (such as text embedding 430 described in FIG. 4) associated with a shading modality and a corresponding condition vector (such as condition vector 435 described in FIG. 4), i.e., condition vector associated with the shading modality, and guides the diffusion network (such as diffusion network 450 described in FIGS. 4 and 6-8) during the denoising process to efficiently generate a synthetic output (such as synthetic output 455 described in FIG. 4) that is associated with the intrinsic modality, i.e., shading.

At operation 905, the system obtains an input image depicting a scene and an input prompt indicating an intrinsic modality. In some cases, the operations of this step refer to, or may be performed by, a user interface as described with reference to FIGS. 4, 14, and 15.

For example, in some cases, the user interface of the image processing apparatus (such as image processing apparatus 1400 described with reference to FIG. 14) receives an input image from a user. In some examples, the input image depicts a scene. In some examples, the image processing apparatus receives the input image from a database or any other data source. Additionally or alternatively, the user interface receives an input prompt from the user. In some examples, the input prompt indicates an intrinsic modality, e.g., albedo, shading, and surface normal.

At operation 910, the system encodes, using a conditional image encoder, the input image to obtain a condition embedding representing the intrinsic modality of the input image. In some cases, the operations of this step refer to, or may be performed by, a conditional image encoder as described with reference to FIG. 15.

According to an embodiment of the present disclosure, the conditional image encoder (such as conditional image encoder 410 as described with reference to FIG. 4) comprises a sequence of residual blocks (such as residual block 415) followed by a transformer network (such as transformer network 420). In some examples, the conditional image encoder comprises eight shared layers of residual blocks R(·) that map image I∈ [symbol] ^{W×H×3} into

$$R ( I ) ∈ {ℝ}^{\frac{W}{8} \times \frac{H}{8} \times 320} .$$

The shared layers are followed by the transformer network including domain-specific transformer layers (such as first output block 460, second output block 465, and third output block 470 described with reference to FIG. 4). For example, each of the domain-specific transformer comprises a SwinV2 transformer, i.e., a SwinV2 transformer for each of the normal, shading, and albedo modalities.

In some cases, the domain-specific transformer network T_{*}(·) is applied to R(I), where ‘*’ indicates an intrinsic domain. Accordingly, the output of the conditional image encoder is condition vector

$${c}_{I}^{*} = {T}_{*} ( R ( I ) )$$

(such as condition vector 435 described with reference to FIG. 4 that comprises a condition vector associated with each of the modalities—albedo, shading, and surface normal). In some cases, the condition vector along with the corresponding text embedding (such as one of the text embedding 430) is used as a condition for the control network 445. Further details regarding an operation of the control network are provided with reference to FIGS. 4 and 10.

At operation 915, the system generates, using an image generation model, a synthetic output based on the intrinsic modality and the condition embedding, where the synthetic output includes a representation of the scene based on the intrinsic modality. In some cases, the operations of this step refer to, or may be performed by, an image generation model as described with reference to FIGS. 4, 14, and 15.

In some cases, the diffusion backward pass for each modality is initiated from a random 2D Gaussian noise and proceeds with the modality-specific conditioning image feature vectors

$${c}_{I}^{*}$$

and the corresponding text embeddings P_{*} (such as text embedding 430 in FIG. 4). The diffusion model adopts linear LDR (e.g., an image type with a limited range of brightness values) images I as the image condition. In some cases, gamma correction is inverted through

$$I = {I}_{sRGB}^{2.2}$$

when the input is presented in the sRGB space.

At each time step, the diffusion network predicts a velocity value (i.e., instead of predicting noise as described in FIGS. 6-8), which is converted to an intermediate latent noise map. The diffusion model then predicts clean latent vectors which are decoded to images. In an exemplary embodiment, diffusion is performed for four initial random seeds and the output images are averaged for each modality. Accordingly, by averaging the output images for each modality, embodiments of the present disclosure are able to reduce the impact of randomness in initial noise sampling.

Therefore, a method for image processing is described. One or more aspects of the method include obtaining an input image depicting a scene and an input prompt indicating an intrinsic modality; encoding, using a conditional image encoder, the input image to obtain a condition embedding representing the intrinsic modality of the input image; and generating, using an image generation model, a synthetic output based on the intrinsic modality and the condition embedding, wherein the synthetic output comprises a representation of the scene based on the intrinsic modality.

Some examples of the method, apparatus, and non-transitory computer readable medium further include encoding the input prompt to obtain a text embedding, wherein the synthetic output is generated based on the text embedding.

Some examples of the method, apparatus, and non-transitory computer readable medium further include encoding the input image to obtain a plurality of condition embeddings corresponding to a plurality of intrinsic modalities. Some examples further include selecting the condition embedding from the plurality of condition embeddings based on the input prompt.

Some examples of the method, apparatus, and non-transitory computer readable medium further include generating control guidance based on the condition embedding. Some examples further include providing the control guidance to the image generation model.

Some examples of the method, apparatus, and non-transitory computer readable medium further include obtaining a noise map. Some examples further include denoising the noise map based on the condition embedding to generate the synthetic output. In some aspects, the intrinsic modality is selected from a set comprising at least one of a shading modality, an albedo modality, and a normal modality.

### Training

Embodiments of the present disclosure include an image generation model configured to perform a decomposition of the joint intrinsic layers of an input image. In some cases, the image generation model comprises a condition image encoder and a control network configured to guide a denoising process of a diffusion model. According to an embodiment, the control network refers to a joint control branch that adapts to each modality via different input prompts (e.g., shading, albedo, or surface normal).

In some cases, the image generation model comprises a multimodal framework that provides for the model to be trained on different datasets including different types of annotations. For instance, the control network is trained to jointly learn three output modalities, e.g., albedo, shading, and surface normal. In some examples, the control network is trained by combining the training data for different modalities with the corresponding prompts.

According to an embodiment, the control network guides the diffusion model (e.g., a latent diffusion model) and the weights of the diffusion model are frozen during the training process. In some cases, the conditional image encoder comprises a sequence of residual blocks and a plurality of transformer layers. In some cases, the weight of the residual block in the conditional image encoder is shared between different modalities. In some cases, the plurality of transformer layers are separately used to map intermediate features of each modality.

FIG. 10 shows an example of a method 1000 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system obtains training data including an input image and an input prompt indicating an intrinsic modality. In some cases, the operations of this step refer to, or may be performed by, an image generation model as described with reference to FIGS. 4, 14, and 15.

According to an embodiment of the present disclosure, the training data comprises a training input image depicting a scene and a training input prompt indicating a desired intrinsic modality (e.g., intrinsic modality described with reference to at least FIGS. 2 and 4). For example, the training input prompt refers to an intrinsic modality, e.g., albedo, shading, and surface normal.

At operation 1010, the system trains, using the training data, a conditional image encoder to generate a condition embedding representing the intrinsic modality of the input image. In some cases, the operations of this step refer to, or may be performed by, a training component as described with reference to FIG. 14.

In some cases, the conditional image encoder (such as conditional image encoder 410 described with reference to FIG. 4) is a joint image encoder that comprises a sequence of residual blocks (such as residual blocks 415 described with reference to FIG. 4) followed by multiple domain-specific transformer layers (such as first output block 460, second output block 465, and third output block 470 described with reference to FIG. 4). In some cases, the weights of the conditional image encoder are initialized randomly during the training process.

For instance, the conditional image encoder generates a condition embedding (such as condition vector 435 described with reference to FIG. 4)

$${c}_{I}^{*} = {T}_{*} ( R ( I ) ) ,$$

where ‘*’ represents an intrinsic domain, R(·) represents the residual blocks, and T_{*}(·) represents the domain-specific transformer layer. In some cases, the condition embedding corresponds to each of the modalities (e.g., albedo, shading, and surface normal). For instance, each of the condition embeddings represents one of the intrinsic modalities. In some cases, the condition embedding is used as a condition for control network (such as control network 445 described with reference to FIG. 4). Further details regarding the generation of the condition embedding are provided with reference to FIGS. 4 and 9.

At operation 1015, the system trains, using the training data, a control network of the image generation model to generate control guidance for the image generation model based on the intrinsic modality and the condition embedding. In some cases, the operations of this step refer to, or may be performed by, a training component as described with reference to FIG. 14.

According to an embodiment, the control network is trained to jointly learn three output modalities, i.e., albedo, shading, and surface normal. In some cases, weights of a base latent diffusion model (such as diffusion model described with reference to FIGS. 6-8) are frozen during the training process. In some cases, the control network is trained by combining the training data for different modalities with the corresponding prompts.

For example, a name of the target modality, for example “Shading”, is used as the text prompt. In some examples, a text encoder (such as text encoder 1520 described with reference to FIG. 15) is used to encode the text prompt to generate a text embedding (such as text embedding 430 corresponding to each modality described with reference to FIG. 4). In some cases, the prompt is fixed and modality-specific.

In case of a randomly sampled time step t, the diffusion model predicts the noise added to the latent mapping,

$${z}_{0}^{*} ,$$

of the corresponding ground-truth modality:

$$ℒ = {𝔼}_{{z}_{0}^{*} , {P}_{*} , ϵ \sim 𝒩 , t , {c}_{I}^{*}} [ {‖ ϵ - {ϵ}_{θ} ( {z}_{t}^{*} , t , {P}_{*} , {c}_{I}^{*} ) ‖}_{2}^{2} ] \qquad ( 9 )$$

where

$${c}_{I}^{*}$$

is the conditioning image feature vector, and P_{*} is the embedding of the corresponding prompt. In some cases, a zero signal-to-noise ratio (SNR) is enforced when sampling the noise e during the training of the U-Net ϵ_{θ}(·) (such as U-Net described with reference to FIGS. 4 and 7). Accordingly, by enforcing zero SNR when sampling the noise, embodiments of the present disclosure are able to enhance congruence between training and inference which provides for synthetic data that better aligns with the original data distribution.

According to an embodiment, zero SNR implements V-prediction and V-loss to ensure the diffusion network can learn a meaningful data distribution as the SNR approaches zero. In some cases, the diffusion network (such as diffusion network 450 described with reference to FIG. 4) predicts velocity (e.g., instead of predicting noise):

$${v}_{t} = \sqrt{{\overline{α}}_{t}} ϵ - \sqrt{1 - {\overline{α}}_{t}} {z}_{0}^{*} , \qquad ( 10 )$$

$$ℒ = {𝔼}_{{z}_{0}^{*} , {P}_{*} , ϵ \sim 𝒩 , t , {c}_{I}^{*}} [ {‖ {v}_{t} - {\tilde{v}}_{θ} ( {z}_{t}^{*} , t , {P}_{*} , {c}_{I}^{*} ) ‖}_{2}^{2} ] \qquad ( 11 )$$

where \tilde{ν}_{θ}(·) is identical to ϵ_{θ}(·) in terms of architecture. In some cases, \tilde{ν}_{θ}(·) is trained for the velocity domain.

In some cases, the different modalities (i.e., (i.e., albedo, shading, surface normal) are combined during training to accommodate the multiple intrinsic modalities in the same latent space of the diffusion model. Particularly, a single training batch is constructed by balancing the number of annotation-input pairs for each modality obtained from different datasets. Therefore, the residual blocks R(·), the transformers T_{A}(·), T_{S}(·), and T_{N}(·), and the control network \tilde{ν}_{θ}(·) can be optimized jointly during the gradient back-propagation. As used herein, T_{A}(·), T_{S}(·), and T_{N}(·) correspond to the transformers associated with the albedo, shading, and surface normal modalities, respectively.

In some examples, the shading values in a scene provided by an input image can span a wide range of values with a long-tailed distribution. According to an exemplary embodiment, the base latent diffusion model (such as diffusion network described with reference to FIGS. 6-8) generates images in the range [0, 1]. In some examples, the image generation model of the present disclosure can normalize the shading layer S∈[0, ∞)³ using

$${S}^{′} = 1 - \frac{1}{1 + S} .$$

For example, the ‘1-’ is added to an inverse shading formula to keep the bright region in the original shading map bright, i.e., monotonic mapping.

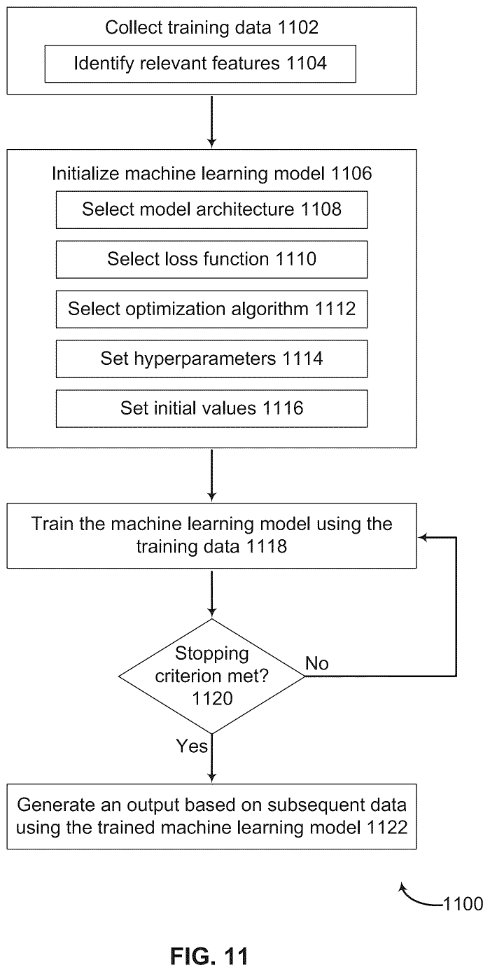

FIG. 11 shows an example of a method of training a machine learning model according to aspects of the present disclosure. FIG. 11 is a flow diagram depicting an algorithm as a step-by-step procedure 1100 in an example implementation of operations performable for training a machine-learning model. In some embodiments, the procedure 1100 describes an operation of the training component 1425 described for configuring the image generation model 1415 as described with reference to FIG. 14. The procedure 1100 provides one or more examples of generating training data, use of the training data to train a machine-learning model, and use of the trained machine-learning model to perform a task.

To begin in this example, a machine-learning system collects training data (block 1102) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1104) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1106). Initialization of the machine-learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1110). The loss function is utilized to measure a difference between an output of the machine-learning model (i.e., predictions) and target values (e.g., as expressed by the training data) to be used to train the machine-learning model. Additionally, an optimization algorithm is selected (1112) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1114) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1118) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1120), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), the procedure 1100 continues training of the machine-learning model using the training data (block 1118) in this example.

If the stopping criterion is met (“yes” from decision block 1120), the trained machine-learning model is then utilized to generate an output based on subsequent data (block 1122). The trained machine-learning model, for instance, is trained to perform a task as described above and therefore once trained is configured to perform that task based on subsequent data received as an input and processed by the machine-learning model. The machine learning model, is an example of, or includes aspects of, the corresponding element described with reference to FIGS. 2, 4-8, and 14-15.

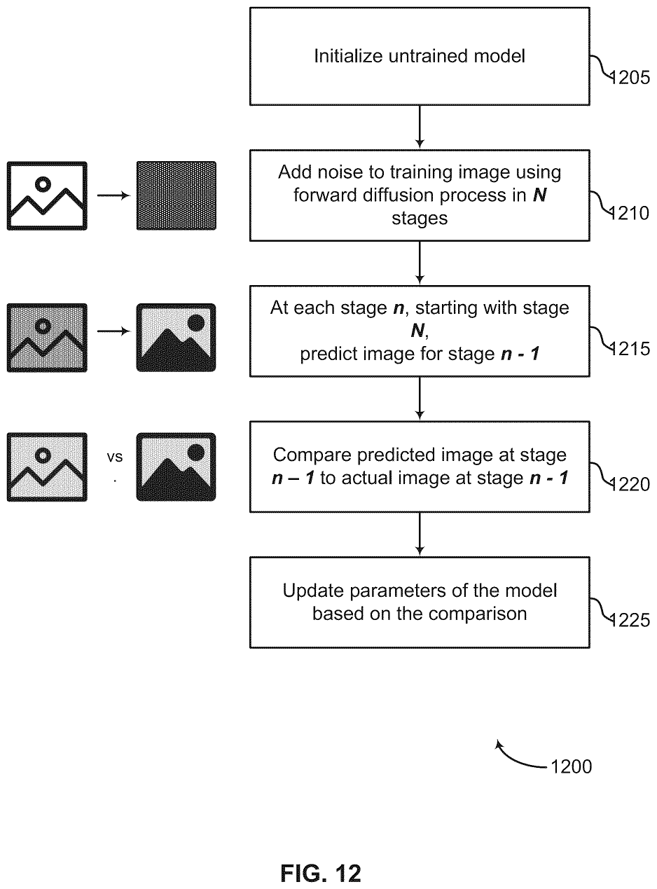

FIG. 12 shows an example of a method of training a diffusion model 1200 according to aspects of the present disclosure. In some embodiments, the method 1200 describes an operation of the training component 1425 described for configuring the image generation model 1415 as described with reference to FIG. 14. The method 1200 represents an example for training a reverse diffusion process as described above with reference to FIGS. 6-8. In some examples, these operations are performed by a system including a processor executing a set of codes to control functional elements of an apparatus, such as the guided diffusion model described in FIG. 6.

Additionally or alternatively, certain processes of method 1200 may be performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 12, according to some aspects, a training component (such as the training component 1425 described with reference to FIG. 14) trains a diffusion model (such as the image generation model described with reference to FIGS. 4 and 6-8) to generate an output.

At operation 1205, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1210, the system adds noise to a training image (or an additional training image) using a forward diffusion process (such as the forward diffusion process described with reference to FIG. 6) in N stages. In some cases, the operations of this step refer to, or may be performed by, a training component as described with reference to FIG. 14.

At operation 1215, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1220, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1225, the system updates parameters of the model based on the comparison. For example, parameters of a U-Net may be updated using gradient descent. Time-dependent parameters of the Gaussian transitions can also be learned.

Accordingly, a method for image processing is described. One or more aspects of the method include obtaining training data including an input image and an input prompt indicating an intrinsic modality; training, using the training data, a conditional image encoder to generate a condition embedding representing the intrinsic modality of the input image; and training, using the training data, a control network of the image generation model to generate control guidance for the image generation model based on the intrinsic modality and the condition embedding.

Some examples of the method, apparatus, and non-transitory computer readable medium further include obtaining a ground-truth output corresponding to the intrinsic modality. Some examples of the method, apparatus, and non-transitory computer readable medium further include computing a diffusion loss (e.g., Norm-2) based on the ground-truth output. Some examples further include updating the parameters of the conditional image encoder and the control network based on the diffusion loss (e.g., Norm-2).

Some examples of the method, apparatus, and non-transitory computer readable medium further include training the conditional image encoder to generate an additional condition embedding representing an additional intrinsic modality. Some examples further include training the control network to generate additional control guidance based on the additional condition embedding and the additional intrinsic modality.

Some examples of the method, apparatus, and non-transitory computer readable medium further include obtaining additional ground-truth output corresponding to the additional intrinsic modality. Some examples of the method, apparatus, and non-transitory computer readable medium further include freezing parameters of the image generation model while training the conditional image encoder and the control network.

Some examples of the method, apparatus, and non-transitory computer readable medium further include generating, using the image generation model, a synthetic output based on the intrinsic modality and the condition embedding, wherein the synthetic output comprises a representation of a scene based on the intrinsic modality. In some aspects, the intrinsic modality is selected from a set comprising at least one of a shading modality, an albedo modality, and a normal modality.

### Implementation and Evaluation

According to an exemplary embodiment of the present disclosure, the image generation model is evaluated on synthetic and real datasets. An exemplary embodiment is configured to perform a comparison with existing methods and show performance on various challenging cases where the image generation model of the present disclosure shows enhanced performance in terms of generalizability, visual quality, and competitive quantitative performance on benchmark datasets. For instance, the image generation model is implemented in applications such as, but not limited to, retexturing and relighting.

In some examples, the image generation model of the present disclosure is trained using 8 NVIDIA A100 GPUs with a batch size of 32 for 320K iterations, in approximately 65 hours. In some examples, the control network (i.e., ControlNet) is trained with the zero SNR strategy on a base latent diffusion model also pre-trained with the zero SNR strategy. According to an example, the image generation model is trained on a mixture of datasets comprising ground-truth albedo and surface normal, and ground-truth/computed HDR shading. In some examples, the images are resized to 384×384 pixels for training.

An exemplary embodiment of the disclosure is configured to evaluate the albedo estimation on IIW scene-centric dataset. In some cases, the shading estimation is evaluated according to an average challenge precision metric on SAW benchmark dataset. Additionally, pixel-wise intrinsic image predictions are evaluated on the synthetic ARAP benchmark dataset based on scale-invariant quantitative metrics such as mean-squared error (MSE), local mean-squared error (LMSE).

According to an exemplary embodiment of the present disclosure, the albedo predicted by the image generation model outperforms existing methods in terms of texture details and color consistency on internet images. In some examples, the predicted albedo provides for different chromaticity between the input image and the albedo, e.g., over-exposure, under-exposure, or complex intra-scene colorful reflections. The image generation model is able to generate a synthetic output with improved quality and performs inpainting of the over-exposed area with reasonable content. Additionally, the predicted albedo is visually consistent with the input image and substantially outperforms existing methods in fine-grained reconstruction.

According to an exemplary embodiment of the present disclosure, the shading predicted by the image generation model outperforms existing methods in terms of smoothness of the shading and correctness of the shading color. In some examples, existing methods depict a degraded performance when high resolution input images are used. By contrast, the image generation model of the present disclosure exhibits consistent performance even when applied to high-resolution input images.

In some cases, existing methods are unable to accurately decode the underlying surface geometry, leading to non-smooth shading on planar areas. The image generation model of the present disclosure predicts shading, e.g., a colorful HDR shading with RGB channels, which is used in image editing tasks. Additionally, the predicted shading for the oversaturated area has a wide range and can be used to consistently adjust the brightness of the scene.

Embodiments of the present disclosure are configured to enable joint learning of different modalities. According to an example, surface normal annotations enable the image generation model to show an improved performance in albedo and shading estimations. For instance, the surface normal estimation is used in cases when frequent shading variations challenge the smooth shading assumption. In some cases, the image generation model of the present disclosure is able to gain an improved understanding of the shape variations, enabling the model to decide prediction of smooth shading.

In some examples, the architecture of the conditional image encoder T_{*}(R(·)) is ablated by training based on the convolution-based encoder of the control network. Accordingly, the conditional image encoder is able to improve an alignment of the color of the input image and the predicted synthetic output. Additionally, the diffusion network trained with the zero SNR further aligns the color distribution of the intrinsic layers resulting in an improved image reconstruction.

### Computing Device

FIG. 13 an example of a computing device according to aspects of the present disclosure. The computing device 1300 may be an example of the image processing apparatus 1400 described with reference to FIG. 14. In one aspect, computing device 1300 includes processor(s) 1305, memory subsystem 1310, communication interface 1315, I/O interface 1320, user interface component(s) 1325, and channel 1330.

In some embodiments, computing device 1300 is an example of, or includes aspects of, the image generation model of FIGS. 14-15. In some embodiments, computing device 1300 includes one or more processors 1305 that can execute instructions stored in memory subsystem 1310 to perform media generation.

According to some aspects, computing device 1300 includes one or more processors 1305. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1315 operates at a boundary between communicating entities (such as computing device 1300, one or more user devices, a cloud, and one or more databases) and channel 1330 and can record and process communications. In some cases, communication interface 1315 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1320 is controlled by an I/O controller to manage input and output signals for computing device 1300. In some cases, I/O interface 1320 manages peripherals not integrated into computing device 1300. In some cases, I/O interface 1320 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1320 or via hardware components controlled by the I/O controller.

According to some aspects, user interface component(s) 1325 enable a user to interact with computing device 1300. In some cases, user interface component(s) 1325 include an audio device, such as an external speaker system, an external display device such as a display screen, an input device (e.g., a remote-control device interfaced with a user interface directly or through the I/O controller), or a combination thereof. In some cases, user interface component(s) 1325 include a GUI.

FIG. 14 shows an example of an image processing apparatus 1400 according to aspects of the present disclosure. Image processing apparatus 1400 is an example of, or includes aspects of, the corresponding element described with reference to FIGS. 1 and 3. In one aspect, image processing apparatus 1400 includes processor unit 1405, memory unit 1410, I/O module 1420, and training component 1425. Training component 1425 updates parameters of the image generation model 1415 stored in memory unit 1410. In some examples, the training component 1425 is located outside the image processing apparatus 1400.

According to some aspects, processor unit 1405 comprises a processing device coupled to the memory component. Processor unit 1405 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1405 is configured to operate a memory array using a memory controller. In other cases, a memory controller is integrated into processor unit 1405. In some cases, processor unit 1405 is configured to execute computer-readable instructions stored in memory unit 1410 to perform various functions. In some aspects, processor unit 1405 includes special purpose components for modem processing, baseband processing, digital signal processing, or transmission processing. According to some aspects, processor unit 1405 comprises one or more processors described with reference to FIG. 13.

Memory unit 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1405 to perform various functions described herein.

In some cases, memory unit 1410 includes a basic input/output system (BIOS) that controls basic hardware or software operations, such as an interaction with peripheral components or devices. In some cases, memory unit 1410 includes a memory controller that operates memory cells of memory unit 1410. For example, the memory controller may include a row decoder, column decoder, or both. In some cases, memory cells within memory unit 1410 store information in the form of a logical state. According to some aspects, memory unit 1410 is an example of the memory subsystem 1310 described with reference to FIG. 13.

According to some aspects, image processing apparatus 1400 uses one or more processors of processor unit 1405 to execute instructions stored in memory unit 1410 to perform functions described herein. For example, the image processing apparatus 1400 may obtain an input image depicting a scene and an input prompt indicating an intrinsic modality; encode, using a conditional image encoder, the input image to obtain a condition embedding representing the intrinsic modality of the input image; and generate, using an image generation model, a synthetic output based on the intrinsic modality and the condition embedding, wherein the synthetic output comprises a representation of the scene based on the intrinsic modality.

In one aspect, memory unit 1410 includes image generation model 1415 trained to obtain an input image depicting a scene and an input prompt indicating an intrinsic modality; encode, using a conditional image encoder, the input image to obtain a condition embedding representing the intrinsic modality of the input image; and generate, using an image generation model, a synthetic output based on the intrinsic modality and the condition embedding, wherein the synthetic output comprises a representation of the scene based on the intrinsic modality. For example, after training, the image generation model 1415 may perform inferencing operations as described with reference to FIGS. 1-3 to obtain an input image depicting a scene and an input prompt indicating an intrinsic modality; encode, using a conditional image encoder, the input image to obtain a condition embedding representing the intrinsic modality of the input image; and generate, using an image generation model, a synthetic output based on the intrinsic modality and the condition embedding, wherein the synthetic output comprises a representation of the scene based on the intrinsic modality.

In some embodiments, the image generation model 1415 is an Artificial neural network (ANN) comprising a plurality of networks including the transformer model described with reference to FIG. 5, the guided diffusion model described with reference to FIG. 6, and the U-Net described with reference to FIG. 7. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 1415 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1425 may train the image generation model 1415. For example, parameters of the image generation model 1415 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 11). The goal of the training process may be to find optimal values for the parameters that allow the image generation model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 1415 can be used to make predictions on new, unseen data (i.e., during inference).

According to some aspects, image generation model 1415 obtains an input image. In some aspects, the input image depicts a scene and the generated synthetic output modifies an intrinsic modality (e.g., shading, albedo, or normal) of the input image. In some examples, image generation model 1415 obtains an input text indicating the intrinsic modality.

According to some aspects, image generation model 1415 is comprising parameters stored in the at least one memory component, wherein the image generation model 1415 comprises a conditional image encoder trained to generate a condition embedding representing the intrinsic modality of the input image, and wherein a control network of the image generation model 1415 to generate control guidance for the image generation model based on the intrinsic modality and the condition embedding.

According to some aspects, image generation model 1415 obtains an input image depicting a scene and an input prompt indicating an intrinsic modality. In some examples, image generation model 1415 generates a synthetic output based on the intrinsic modality and the condition embedding, where the synthetic output includes a representation of the scene based on the intrinsic modality. In some aspects, the intrinsic modality is selected from a set including at least one of a shading modality, an albedo modality, and a normal modality.

According to some aspects, image generation model 1415 obtains training data including an input image and an input prompt indicating an intrinsic modality. In some examples, image generation model 1415 obtains a ground-truth output corresponding to the intrinsic modality. In some examples, image generation model 1415 obtains additional ground-truth output corresponding to the additional intrinsic modality. In some examples, image generation model 1415 generates a synthetic output based on the intrinsic modality and the condition embedding, where the synthetic output includes a representation of a scene based on the intrinsic modality. In some aspects, the intrinsic modality is selected from a set including at least one of a shading modality, an albedo modality, and a normal modality.

According to some aspects, image generation model 1415 comprises obtaining an input image depicting a scene and an input prompt indicating an intrinsic modality. In some examples, image generation model 400 generates a synthetic output based on the intrinsic modality and the condition embedding, wherein the synthetic output comprises a representation of the scene based on the intrinsic modality. In some aspects, the image generation model 1415 includes a diffusion network (such as diffusion network described with reference to FIGS. 4 and 6-8). Image generation model 1415 is an example of, or includes aspects of, the corresponding element described with reference to FIGS. 4 and 15.

I/O module 1420 receives inputs from and transmits outputs of the image processing apparatus 1400 to other devices or users. For example, I/O module 1420 receives inputs for the image generation model 1415 and transmits outputs of the image generation model 1415. According to some aspects, I/O module 1420 is an example of the I/O interface 1320 described with reference to FIG. 13.

According to some aspects, training component 1425 trains, using the training data, a conditional image encoder to generate a condition embedding representing the intrinsic modality of the input image. In some examples, training component 1425 trains, using the training data, a control network of the image generation model 1415 to generate control guidance for the image generation model 1415 based on the intrinsic modality and the condition embedding. In some examples, training component 1425 computes a diffusion loss (e.g., Norm-2) based on the ground-truth output. In some examples, training component 1425 updates the parameters of the conditional image encoder and the control network based on the diffusion loss (e.g., Norm-2).

In some examples, training component 1425 trains the conditional image encoder to generate an additional condition embedding representing an additional intrinsic modality. In some examples, training component 1425 trains the control network to generate additional control guidance based on the additional condition embedding and the additional intrinsic modality. In some examples, training component 1425 freezes parameters of the image generation model 1415 while training the conditional image encoder and the control network.

FIG. 15 shows an example of an image generation model 1500 according to aspects of the present disclosure. Image generation model 1500 is an example of, or includes aspects of, the corresponding element described with reference to FIGS. 4 and 14. In one aspect, image generation model 1500 includes conditional image encoder 1505, text encoder 1520, control network 1525, and diffusion network 1530.

According to some aspects, conditional image encoder 1505 encodes the input image to obtain a condition embedding representing the intrinsic modality of the input image. In some examples, conditional image encoder 1505 encodes the input image to obtain a set of condition embeddings corresponding to a set of intrinsic modalities. In some examples, conditional image encoder 1505 selects the condition embedding from the set of condition embeddings based on the input prompt.

An “embedding” refers to a representation of an object (e.g., the text prompt) in a lower-dimensional space such that semantic information about the object is more easily captured and analyzed by a machine learning model. For example, the embedding is a numerical representation of the object in a continuous vector space in which objects that include similar semantic information to each other correspond to vectors that are numerically similar to and thus “closer” to each other, thereby allowing a similarity between different objects corresponding to different embeddings to be readily determined. A “text embedding” refers to an embedding of the text prompt, e.g., a representation of the text prompt in an embedding space.

An “embedding space” (or a “vector space”) refers to a set having embeddings (or vectors) as elements, and is characterized by a dimension specifying a number of independent directions in the embedding space. According to some aspects, the embedding space is a multi-modal embedding space that is shared by text embeddings and image embeddings, such that a text embeddings and an image embedding may be compared with each other.

According to some aspects, conditional image encoder 1505 encodes the input image to obtain a condition embedding representing the intrinsic modality of the input image. In one aspect, conditional image encoder 1505 includes preliminary encoder 1510 and output block 1515. In some aspects, the conditional image encoder 1505 includes a set of output blocks 1515 corresponding to a set of intrinsic modalities, respectively. In some aspects, the conditional image encoder 1505 includes a preliminary encoder 1510 trained to provide a preliminary condition embedding to each of the set of output blocks 1515.

In some aspects, each of the set of output blocks 1515 includes a transformer network. According to some aspects, a transformer comprises one or more ANNs comprising attention mechanisms that enable the transformer to weigh an importance of different words or tokens within a sequence. Further details regarding the transformer network are provided with reference to FIG. 5.

According to some aspects, text encoder 1520 encodes the input prompt to obtain a text embedding, where the synthetic output is generated based on the text embedding.

According to some aspects, control network 1525 generates control guidance based on the condition embedding. In some examples, control network 1525 provides the control guidance to the image generation model 1500. In some aspects, the control network 1525 includes a ControlNet architecture.

According to some aspects, diffusion network 1530 obtains a noise map. In some examples, diffusion network 1530 denoises the noise map based on the condition embedding to generate the synthetic output. Diffusion network 1530 is an example of, or includes aspects of, the corresponding element described with reference to FIGS. 4 and 6-8.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image processing, comprising:
obtaining an input image depicting a scene and an input prompt indicating an intrinsic modality of the input image, wherein the intrinsic modality determines how the scene interacts with light;
encoding, using a conditional image encoder, the input image to obtain a condition embedding representing the intrinsic modality of the input image; and
generating, using an image generation model, a synthetic output based on the input prompt and the condition embedding, wherein the synthetic output comprises a visual representation of the intrinsic modality of the input image.

2. The method of claim 1, further comprising:
encoding the input prompt to obtain a text embedding, wherein the synthetic output is generated based on the text embedding.

3. The method of claim 1, wherein encoding the input image comprises:
encoding the input image to obtain a plurality of condition embeddings corresponding to a plurality of intrinsic modalities; and
selecting the condition embedding from the plurality of condition embeddings based on the input prompt.

4. The method of claim 1, wherein generating the synthetic output comprises:
generating control guidance based on the condition embedding; and
providing the control guidance to the image generation model.

5. The method of claim 1, wherein generating the synthetic output comprises:
obtaining a noise map; and
denoising the noise map based on the condition embedding to generate the synthetic output.

6. The method of claim 1, wherein:
the intrinsic modality is selected from a set comprising at least one of a shading modality, an albedo modality, and a normal modality.

7. A method of training an image generation model, the method comprising:
obtaining training data including an input image and an input prompt indicating an intrinsic modality;
generating a predicted condition embedding based on the input prompt; and
training, using the training data and the predicted condition embedding, a conditional image encoder to generate a condition embedding for an image generation model, wherein the condition embedding represents the intrinsic modality of the input image.

8. The method of claim 7, further comprising:
training, using the training data, a control network of the image generation model to generate control guidance for the image generation model based on the intrinsic modality and the condition embedding.

9. The method of claim 7, wherein training the conditional image encoder comprises:
generating a synthetic image based on the predicted condition embedding;
computing a diffusion loss based on the synthetic image; and
updating the parameters of the conditional image encoder based on the diffusion loss.

10. The method of claim 7, further comprising:
training the conditional image encoder to generate an additional condition embedding representing an additional intrinsic modality.

11. The method of claim 10, further comprising:
training a control network of the image generation model to generate additional control guidance based on the additional condition embedding.

12. The method of claim 7, further comprising:
freezing parameters of the image generation model while training the conditional image encoder.

13. The method of claim 7, further comprising:
generating, using the image generation model, a synthetic output based on the intrinsic modality and the condition embedding, wherein the synthetic output comprises a representation the intrinsic modality for a scene.

14. The method of claim 7, wherein:
the intrinsic modality is selected from a set comprising at least one of a shading modality, an albedo modality, and a normal modality.

15. A system comprising:
a memory component; and
a processing device coupled to the memory component, the processing device configured to perform operations comprising:
obtaining an input image depicting a scene and an input prompt indicating an intrinsic modality of the input image, wherein the intrinsic modality determines how the scene interacts with light;
encoding, using a conditional image encoder, the input image to obtain a condition embedding representing the intrinsic modality of the input image; and
generating, using an image generation model, a synthetic output based on the input prompt and the condition embedding, wherein the synthetic output comprises a visual representation of the intrinsic modality of the input image.

16. The system of claim 15, wherein:
the conditional image encoder comprises a plurality of output blocks corresponding to a plurality of intrinsic modalities, respectively.

17. The system of claim 16, wherein:
the conditional image encoder comprises a preliminary encoder trained to provide a preliminary condition embedding to each of the plurality of output blocks.

18. The system of claim 16, wherein:
each of the plurality of output blocks comprises a transformer network.

19. The system of claim 15, wherein:
the image generation model comprises a diffusion network.

20. The system of claim 15, wherein:
the image generation model includes a control network.
